(19) United States
(12) Patent Application Publication
(10) Pub. No.: US 2009/0019427 A1
(43) Pub. Date: Jan. 15, 2009

(54) Method and Apparatus for Providing Requirement Driven Static Analysis of Test Coverage for Web-Based, Distributed Processes

(75) Inventors: Zhong Jie Li, Beijing (CN); He Hui Liu, Beijing (CN); Naomi M. Mitsumori, San Jose, CA (US); Krishna Ratakonda, Yorktown Heights, NY (US); Hua Fang Tan, Beijing (CN); Jun Zhu, Beijing (CN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/777,342

(22) Filed: Jul. 13, 2007

(51) Int. Cl. G06F 9/44

(52) U.S. Cl. 717/126

(57) ABSTRACT

A method (which can be computer implemented) for analyzing test coverage of distributed processes includes the steps of identifying at least one of the processes that is invoked by a test case, mapping at least a portion of the test case to a plurality of specific test paths in the at least one of the processes, and identifying given ones of the test paths as possibly relevant in at least one of the processes, if the test paths are not infeasible.

### FIELD OF THE INVENTION

The present invention relates to the electrical, electronic and computer arts, and more particularly to test plan coverage for processes and the like.

### BACKGROUND OF THE INVENTION

Services oriented architecture (SOA) is fast becoming a popular choice for many enterprises in building a flexible information technology (IT) infrastructure that can adapt quickly and economically to fast changing enterprise needs. Repeatable enterprise tasks or “services” with well defined interfaces, that are independent of the computing platforms and underlying applications, serve as the building blocks for this architecture These “services” are choreographed through composite applications in support of horizontal enterprise processes. Many commercial SOA implementations use Web services standards to promote inter-operability between different software vendors, but these are not the only techniques for realizing a SOA within the enterprise. Business Process Execution Language (BPEL) enables the combination and choreography of individual services into coarse-grained code constructs or enterprise processes which in turn can be used to build workflows that support enterprise requirements through web portals.

A poorly planned SOA implementation can create more problems than it solves—performance bottlenecks, expensive outages and significant implementation delays are the hallmark of such a system In large enterprises, where the number of applications and interfaces that need to be adapted into a SOA framework can be both numerous and complex, these problems are especially difficult to address A significant feature of SOA systems is the repeated reuse of services and enterprise processes in the context of multiple composite applications—thus the same service or process may be invoked in a number of different ways, increasing the probability of failure to a significantly higher degree when compared with a typical non-SOA software application.

Current tools in the SOA testing space are of two types. The first type directly tests Web Services (such as Paiasoft's SOAtest tool) The second type is exemplified by the SOA Validation System from AmberPoint This type validates production traces from Web Service components. With both types, ensuring test coverage back to the system's enterprise requirements must be done manually.

A more common technique to show coverage is to use a requirement-based testing technique during system testing, system integration testing, and user acceptance testing levels The test cases are based on and traced to enterprise requirements, and as such, the underlying architecture becomes transparent to these testers. How the transaction is executing is typically not as important as the results of the execution. There are many tools that support this methodology, such as Mercury's WinRunner and QuickTest Professional (QTP) with TestDirector, and IBM's Rational Functional Tester in combination with Rational TestManager and Rational RequisitePro. However, these tools do not explicitly support SOA and cannot ensure that a change in a single web service will not adversely affect entire systems.

There are tools that will test SOA web services (“white box testing”) without test coverage focus, and there are non-SOA specific tools that will test end-to-end enterprise transactions (“black box testing”) and allow coverage traceability.

It would be desirable to overcome the limitations in the previous approaches.

### SUMMARY OF THE INVENTION

Principles of the present invention provide techniques for providing requirement driven static analyses of test coverage for Web-based, distributed processes In one aspect, an exemplary method (which can be computer implemented) for analyzing test coverage of distributed processes includes the step of identifying at least one of the processes that is invoked by a test case The method further includes the steps of mapping at least a portion of the test case to a plurality of specific test paths in the at least one of the processes, and identifying given ones of the test paths as possibly relevant test paths in the at least one of the processes, if the test paths are not infeasible.

As used herein, including the claims, “facilitating” an action includes performing the action, making the action easier, helping to carry the action out, or causing the action to be performed Thus, by way of example and not limitation, instructions executing on one processor might facilitate an action carried out by instructions executing on a remote processor, by sending appropriate data or commands to cause or aid the action to be performed In some instances, an additional step includes facilitating provision of a report that describes test coverage. The test coverage can be described in a quantitative manner, by identifying a specific sub-set of the test paths that are covered by the test case. The test cover age could also be described in a qualitative manner, by identifying a percentage of the test paths covered by the test case. In one or more embodiments, the step of identifying given test paths as possibly relevant test paths includes identifying substantially all possibly relevant test paths.

In some cases, the test coverage is static test-case coverage and the distributed processes choreograph distributed web-based software modules. At least some of the processes can be defined in Business Process Execution Language (BPEL), if desired

Where desired or required, an additional step can include repeating the steps of identifying at least one of the processes, mapping, and identifying the given test paths for a plurality of additional test cases At least some of the test cases can be described in documents, conceptual use cases, and/or programmatically in an automated test tool. In some instances, the test cases axe actionable test cases and form a portion of a test plan, which further includes a list of desirable outcomes for each of the test cases as well as a list of associated processes for, verifying the desirable outcomes. An additional optional step includes facilitating documenting results of running the test cases The distributed processes can each include, for example, a construct describing choreography of at least one service to complete at least one task. At least some of the constructs can be executable and the test cases can define direct invocation of the executable constructs. In some instances, at least some of the constructs are conceptual, and the test cases define invocation of executable realizations of the conceptual constructs. The at least one service can be, for example, a web service.

In one or more embodiments, in the step of identifying given ones of the test paths, the given test paths are limited to those that can be traced back to enterprise requirements. Further, in some cases, in the step of identifying given test paths, such paths are identified to facilitate test coverage of every service of every service provider associated with the distributed processes. In some instances, at least some of the processes are defined in BPEL, including decision points and branches, and in the step of identifying given test paths, the test paths are identified to facilitate test coverage of all feasible combinations of all the branches of all the decision points In one or more embodiments, in the step of identifying given test paths, such paths are identified to facilitate derivation of multiple test cases for the given test paths.

In another aspect, an exemplary method of analyzing test coverage of distributed processes associated with a plurality of software modules of a customer, the software modules being from a plurality of software vendors, includes the step of identifying, by a service provider; at least one of the processes that is invoked by a test case. The method further includes the steps of mapping, by the service provider; at least a portion of the test case to a plurality of specific test paths in the at least one of the processes, and identifying, by the service provider, given test paths as possibly relevant in at least one of the processes, if the given test paths are not infeasible Yet further, the method includes facilitating provision of a report to the customer that describes test coverage In this particular exemplary aspect, at least some of the software modules of the customer are not products of the service provider

In yet another aspect, an exemplary method for analyzing test coverage of distributed processes associated with a plurality of software modules of a customer includes the step of identification, by a service provider; of at least one of the processes that is invoked by a test case. The method further includes mapping, by the service provider, of at least a portion of the test case to a plurality of specific test paths in at least one of the processes, and identification, by the service provider, of given test paths as possibly relevant test paths in at least one of the processes, if the given test paths are not infeasible Yet further, the method includes facilitating provision of a report to the customer that describes test coverage, and, responsive to the customer indicating that the test coverage requires enhancement, designing at least one new test case to enhance the test coverage.

One or more embodiments of the invention may provide one or more beneficial techniques for analyzing a test plan in terms of coverage. A test plan may describe, for example:
A series of actionable test cases that may be described in the form of a document, in terms of a conceptual “use case,” programmatically in an automated test tool, and/or through other techniques.
A list of desirable outcomes that should result upon the full and/or partial completion of each of the tests in the previous step, and the associated process for verifying such outcomes
Techniques for documenting and/or storing the results of running each of the test cases.

A test plan may also include a description of the testing environment, work loads under which test cases should be run, traceability to enterprise requirements that required the inclusion of particular test cases, and the like. These may not be particularly relevant to all aspects of one or more embodiments of the invention. Some test plans may not define all three elements described above for each individual test, as there may be an implicit assumption on how to document the test result, or because the criteria for failure and/or success of the test are apparent.

One significant concept in one or more instances of the invention is to make a systematic connection between a test case and the enterprise process(es) which are involved in the execution of the test case, and then to use this connection to drive coverage analysis. In this context, an enterprise process may be understood as a conceptual or executable construct which describes the choreography of one or more services to complete a task. A test case may include invoking one or more such enterprise processes directly, if they are executable, or an executable realization of the enterprise process(es) that captures the enterprise logic, if they are conceptual. The invocation may itself involve calling on user interface elements that are not part of the enterprise process

In one or more embodiments of the invention, coverage analysis involves performing several pertinent steps:
1. Identifying the enterprise process(es) that are invoked by each test case,
2. Mapping the test case either automatically or manually to specific path(s) or work-flows in individual enterprise process(es), and
3. Identifying either quantitatively (i.e., a list of test paths) or qualitatively (i.e., percentage of test paths) that are covered by the current set of test cases

The techniques for coverage analysis can be provided as a service to an enterprise, by providing the statistical information gathered using the described techniques, broken down by enterprise process, composite application, service or higher level enterprise requirements. Optionally, an additional service, which involves designing new test cases to achieve a desired level of cover age, may be provided.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus including a memory and at least one processor that is coupled to the memory and operative to perform exemplary method steps

These and other features, aspects, and advantages of the present invention will become apparent from the following detailed description of illustrative embodiments thereof) which is to be read in connection with the accompanying drawings.

### BRIEF DESCRIPTION OF THC DRAWINGS

FIG. 1 illustrates process usage patterns, according to an aspect of the invention;

FIG. 2 presents a table describing various approaches to test design methods for the patterns of FIG. 1;

FIG. 3 illustrates a flow chart of an exemplary inventive method;

FIG. 4 presents a chart describing decision point types and branches in BPEL;

FIG. 5 illustrates decision points and an example test path for a purchase order shipping process according to another aspect of the invention;

FIG. 6 depicts a table of test paths and branches;

FIG. 7 illustrates the combination of selected branches to generate a test path, for still another aspect of the invention;

FIG. 8 presents test paths and the associated decision table fox an exemplary purchase process;

FIG. 9 illustrates “while” handling, according to a further aspect of the invention;

FIG. 10 depicts tabular test path representation;

FIG. 11 shows exemplary test path conditions;

FIG. 12 depicts a tabular, representation of a test path; and

FIG. 13 illustrates a computer system that may be useful in implementing one or more aspects and/or elements of the present invention

### DETAILED DESCRIPTION OF PREFERRED EMBODIMENTS

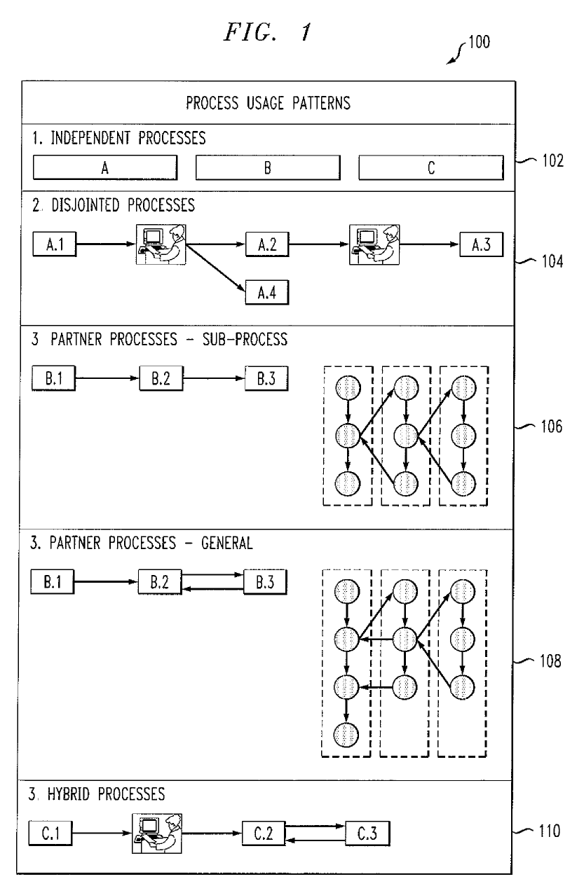

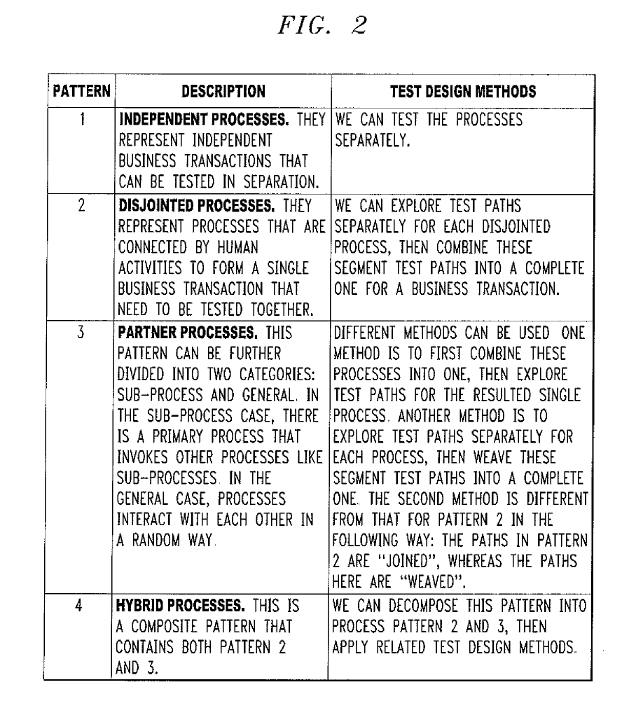

A non-limiting exemplary embodiment of the invention will now be described in the context of enterprise processes defined in BPEL and services defined using web services standards. First, we examine the BPEL processes that are used in real projects A typical SOA system could contain many BPEL processes. With reference to patterns 100 of FIG. 1, block 102 depicts an independent process usage pattern Block 104 depicts a disjointed process usage pattern Block 106 depicts a partner process with various sub-process usage patterns. Block 108 presents a general partner process usage pattern and block 110 presents a hybrid process usage pattern. Each pattern may require a different or a combined test design method. The table of FIG. 2 describes various approaches

A BPEL process typically contains different execution paths, which represent different web service interactions (transaction patterns) between SOA system components. It is desirable to exercise all the possible tuns of a program to detect hidden bugs in testing, so each execution path could correspond to a test path In this description, we use the terms “execution path” and “test path” interchangeably. Test path exploration is performed to find out these different paths; preferably, all the paths beginning from the start node to all the termination nodes of the program. It is desirable to set an upper limit on repetition logic to avoid infinite loops. Test path exploration can be manually done, or aided with automatic tools. We describe an exemplary procedure that testers can follow to explore test paths systematically and easily.

With reference now to FIG. 3, an exemplary method, according to one aspect of the invention, for analyzing test coverage of distributed processes, includes the steps of identifying at least one of the processes that is invoked by a test case, as per block 302, mapping at least a portion of the test case to a plurality of specific test paths in the at least one of the processes, as per block 304, and identifying given ones of the test paths as possibly relevant test paths in the at least one of the processes, if the given ones of the test paths are not infeasible as per block 306. An additional step of repeating steps 302-306 can optionally be performed, to handle a plurality of additional test cases.

In one or more embodiments, we mark up the decision points in the BPEL process. These are places where control logic diverges and different paths form Then, beginning from the start node of the process graph, we follow the control flow, and at each decision point, all branches are exercised to form new test paths After all the test paths have been identified, we analyze their feasibility: whether or not a test path is executable, that is, whether there is proper data to satisfy the branch conditions associated with the path In this step, infeasible test paths can be filtered. Note that the word “we” is not necessarily intended to imply human agency, but also is intended to covert acts or steps carried out by a computer

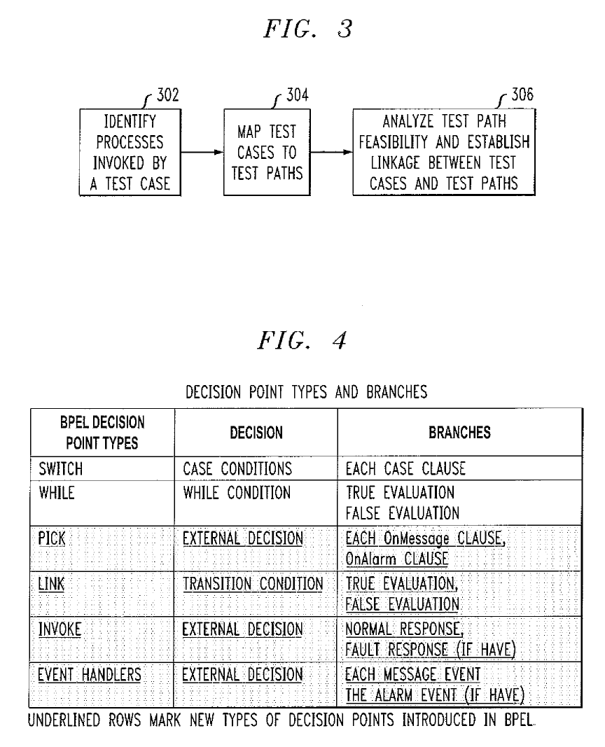

One or more embodiments of the invention provide a mechanism for finding test paths in a BPEL process which is somewhat similar to that of a sequential program: exercising different branches of decision points There are certain aspects introduced in BPEL: new types of decision points including pick, invoke, link, event handlers; and some special control semantics including dead path elimination and exception handling There are six kinds of decision points in a BPEL process, as depicted in the table of FIG. 4 For each decision point, there can be multiple branches, each of which is associated with a condition. If the condition holds, the branch will be selected to execute In the table depicted in FIG. 4, “external decision” means that there are no conditions expressed as Boolean expressions for such decision point; rather, the decision is made by external input messages. The table in FIG. 4 lists, in the third column, the branches that testers may need to exercise to explore various execution scenarios and/or test paths.

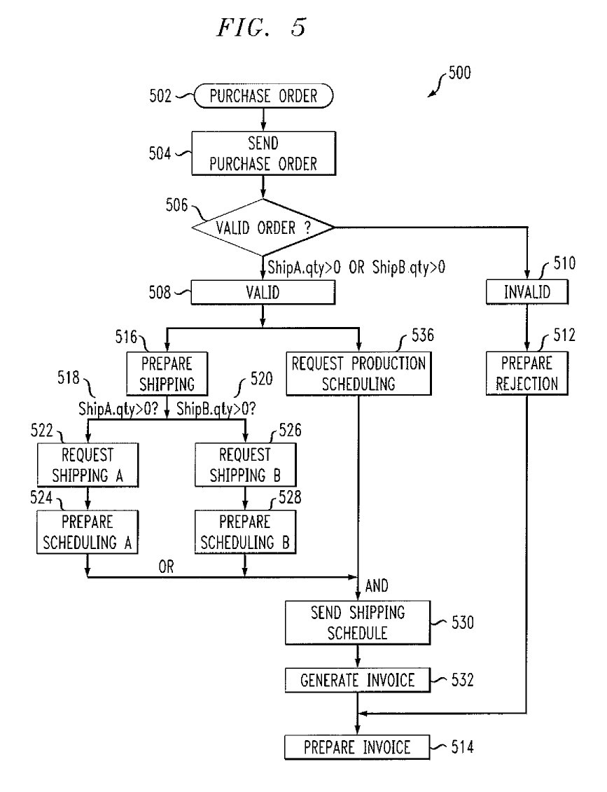

Attention should now be given to FIG. 5 which shows a flow chart 500 of an example of a purchase process that contains three decision points, including a switch that has two case branches, and two links (each is associated with a transition condition). One significant point is that the conditions of the two links can be true at the same time; in other words, they are not necessarily exclusive, as is the case in switch Therefore if several links come out of a node, it has a different semantic than switch Depending on the transition conditions associated with the links, there could be one, two, or any subset of these links that are executed.

In terms of specific details, chart 500 of FIG. 5 shows an exemplary process commencing with a purchase order at block 502. At block 504, the purchase order is sent At block 506, a determination is made whether the purchase order is valid. If not, as per block 510, a rejection is prepared at block 512 and an invoice is prepared at block 514. Conversely, if the purchase order is valid, as per block 508, at block 516, a determination is made whether a non-zero quantity is to be shipped via method A or method B (blocks 518, 520, respectively) Shipping is requested and scheduling prepared for method A at blocks 522, 524 and for method B as per blocks 526, 528 In parallel, production scheduling was requested at block 536. The shipping schedule is sent at block 530, and flow proceeds to block 532, where the invoice is generated.

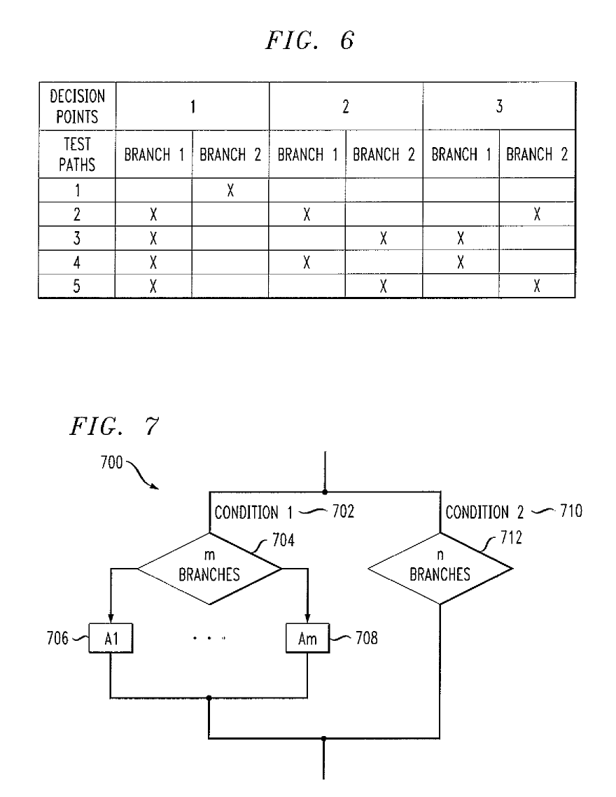

Once all the decision points are found, a tester can exercise their branches to generate test paths For this work, there is an effective technique called a “decision table.” An adapted version of that technique can be used for test path identification and representation In the table of FIG. 6, there is one column for each branch of each decision point, and one row for each combination of branches. An “X” in a branch column shows that the branch is selected in the test path indicated in the row. In this way, a test path is represented as a combination of selected branches The columns of this table can be determined in the previous step. In this step, the control flow can be followed and test paths can be added. It is unnecessary to enumerate all the possible combinations because some branches are independent of each other; that is, they are exclusive and not in the same path. BPEL language features such as link semantics, dead-path-elimination (DPE), and exception handling, are known to the skilled artisan from sections 12 5 1, 12 5.2 and 13 2˜13 4 of the BPEL specification 1 1, all of which is expressly incorporated herein by reference in its entirety for all purposes. Such specification is available from the URL:

http://download.boulder ibm com/ibmdl/pub/software/dw/spees/ws-bpel/ws-bpel.pdf.

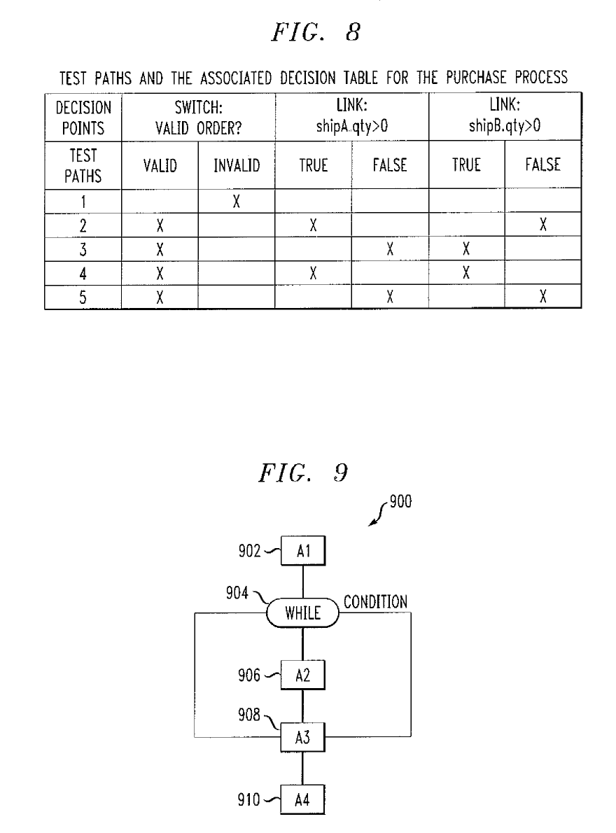

The number of combinations can be very large due to the multiplication effect In the example of FIG. 7, the number is: 1+m+n+m*n. If we take m=3, n=2, this equals to: 12 Sometimes, there is a need to cover all these test paths in testing. Sometimes there may only be a need to target a lower level of coverage, say, each activity in A1 to Am is covered at least once, then at least 1+max(m,n)=4 test paths are needed. The decision of what coverage goal to target is left to testers. The chart 700 of FIG. 7 shows a first condition 702 with m branches, as depicted at block 704. The branches are number A1 (block 706) through Aₘ (block 708) A second decision 710 has n branches as depicted at block 712 In the example of the decision tale of FIG. 8, a purchase order process has five execution scenarios whose required condition combinations are listed therein Test path 1 in FIG. 8 corresponds to the following elements in FIG. 5: 504, 506, 510, 512, 514.

Referring to FIG. 9, for the “while” condition, in a simple blanching approach called the “0-1 criterion”, the behavior inside it is either executed one time, or not executed; however, in the real case, other loop times may be needed. In one or more embodiments, it may be appropriate to employ a “0-*” approach: in the decision table, when the False value of a “while” condition is selected, it means the body behavior will not be executed; when the True value is selected, it means the body behavior will be executed for n times where n is an undetermined positive number We leave the determination of n to a later time, say, when the test paths are refined into test cases, or during test path feasibility analysis Chart 900 shows block A1 at 902; the while condition is block 904. If the condition is False, then we get test path A1.A4 (blocks 902, 910); if the condition is True, we get test paths A1.(A2.A3)ⁿ.A4, where blocks AZ and A3 are numbered 906, 908, respectively.

In one or more embodiments of the invention, we limit our test paths to those that can be traced back to requirements, such as enterprise requirements In practice, many BPEL processes are not rigidly unit tested. Accordingly, if time allows, identifying more test paths with higher coverage goals may potentially provide additional defect-detecting capability.

The following is an exemplary, non-limiting list of common coverage goals for reference
Basic/minimum coverage: every operation of every service of every service provider should be covered at least once.
All-path coverage: all the (feasible) combinations of all the branches of all the decision points should be covered at least once.
Data driven testing: equivalence partition, boundary values—this can be used to derive multiple test cases for one test path.

Thus, referring back to FIG. 3, in some instances, in the step 306 of identifying given ones of the test paths, the given ones of the test paths are limited to those that can be traced back to enterprise requirements. In another aspect, the given ones of the test paths could be identified to facilitate test coverage of every service of every service provider associated with the distributed processes. As noted, at least some of the processes can be defined in Business Process Execution Language (including decision points and branches). In step 306, the given ones of the test paths could be identified to facilitate test coverage of all feasible combinations of all the branches of all the decision points. In yet another aspect (data driven testing), the given ones of the test paths are identified to facilitate derivation of multiple test cases for the given ones of the test paths.

One or more embodiments of the invention provide techniques for analyzing test path feasibility Not all the test paths found so far are feasible, for example in FIG. 8 test path 5 is infeasible since the combination of the selected conditions is unsatisfiable; in such an example a purchase order will be determined as invalid if it has a positive order quantity for neither shipping option. Infeasible test paths should be filtered before the next procedure (refine test paths into test cases) begins. Effort invested in refining infeasible paths is wasteful of time. At the same time, test data that helps decide which branches to take can be determined The feasibility of a test path can be determined based on the collection of conditions that must hold along the path. These conditions are usually defined on variables, which in turn get their value via assignments from other variables as well as input and output messages of the process. Therefore, in addition to conditions, testers also need to examine the related variables and their manipulations, which are essentially the data handling logic in the BPEL process. With all such information, testers could try to calculate a solution for the collections of conditions. If a solution exists, then the test path is feasible; otherwise, it should be discarded If a solution exists, it can be used as the test data. It is desirable that the conditions associated with all the above decision points, as well as assignment activities, be shown in the BPEL graph for testers to enumerate test paths easily Since a BPEL editor may not provide this, it can be implemented, for example, manually or via tooling support.

Other sources of information for path feasibility analysis include enterprise requirements and designs that specify enterprise process rules. If a test path can be traced back to an enterprise scenario and the associated conditions can be determined, testers could use such information for path feasibility analysis, rather than data handling statements in the BPEL program

For “while” decision points as depicted in FIG. 9, the collection of conditions is interesting The condition associated with n times of looping is: condition holds true for n times, and false for 1 time. So in this step, there is a need to determine the n value of the “while” decision point. Testing with several n values is another possible step Therefore, one test path may become several test paths, each with different looping times After the filtering of infeasible test paths, the coverage may be impaired, and there may be a need to re-evaluate the test coverage and design an additional test path to recover the coverage goal if such a step becomes necessary.

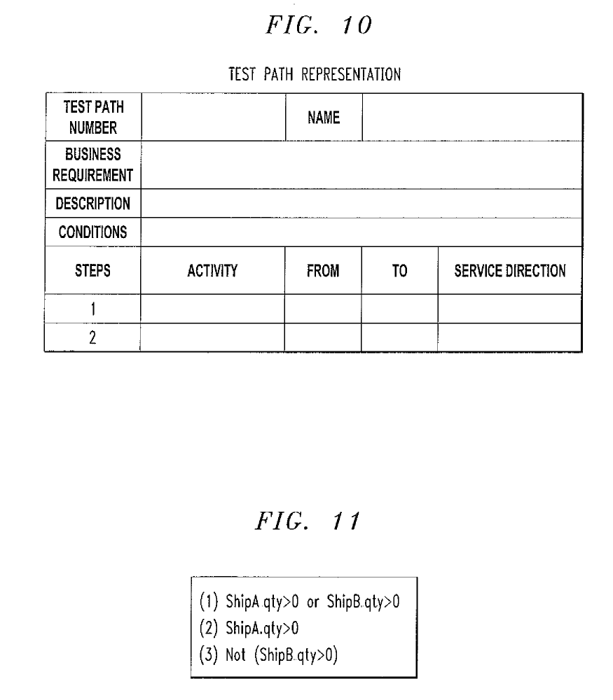

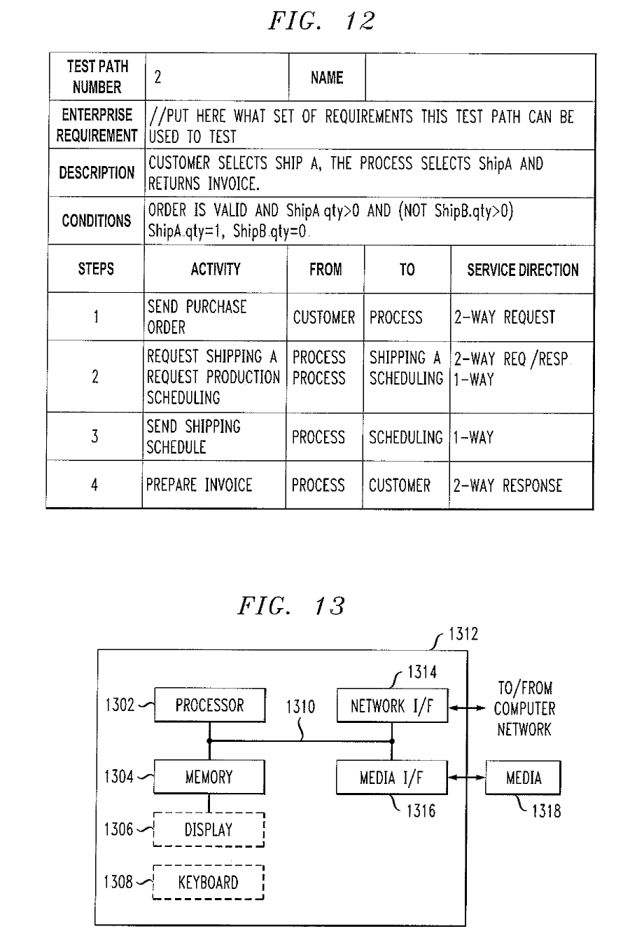

A test path can be represented by the table in FIG. 10, which has omitted the process-internal activities such as decision points and assignments. Additional information is added to test paths: Name, Enterprise requirements, Description and Conditions. In this way, a test path will have more meaning for better understanding and classification in the future. FIGS. 11 and 12 describe test path 2 for the purchase older example of FIG. 8. A solution is: ShipA.qty=1, ShipB.qty=0. Assuming this solution for the example, it can be represented by the table depicted in FIG. 12

It will thus be appreciated that one or more embodiments of the invention help to ensure that a test plan used to certify the reliability of enterprise processes and services in a SOA system provides adequate coverage, and also that it is attained when we have limited knowledge of a customer's IT infrastructure, which is the usual situation. It should be noted that this IT infrastructure might be built by combining assets from multiple vendors, so the complexity level can be quite high.

As discussed above, in one aspect, a services offering is provided In particular, a method for analyzing test coverage of distributed processes associated with a plurality of software modules of a customer, the software modules being from a plurality of software vendors, includes steps 302-306 performed by a service provider The service provider can facilitate provision of a report to the customer that describes the test coverage. At least some of the software modules of the customer are not products of the service provider In the step 306 of identifying given ones of the test paths, the given ones of the test paths can be identified to facilitate test coverage associated with at least one of enterprise process, composite application, service, and higher level enterprise requirements of the customer.

In another aspect, a services offering involves providing new test cases. In particular; a method for analyzing test coverage of distributed processes associated with a plurality of software modules of a customer, involves a service provider performing steps 302 to 306 as just described, facilitating provision of a report as just described, and, responsive to the customer indicating that the test coverage requires enhancement, designing at least one new test case to enhance the test coverage

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps

One or more embodiments can make use of software running on a general purpose computer or workstation. With reference to FIG. 13, such an implementation might employ, for example, a processor 1302, a memory 1304, and an input/output interface formed, for example, by a display 1306 and a keyboard 1308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interfacc” as used herein, is intended to include, for example, one or more mechanisms for inputting data to the processing unit (for example, mouse), and one or more mechanisms for providing results associated with the processing unit (for example, printer). The processor 1302, memory 1304, and input/output interface such as display 1306 and keyboard 1308 can be interconnected, for example, via bus 1310 as part of a data processing unit 1312. Suitable interconnections, for example via bus 1310, can also be provided to a network interface 1314, such as a network card, which can be provided to interface with a computer network, and to a media interface 1316, such as a diskette or CD-ROM drive, which can be provided to interface with media 1318.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU Such software could include, but is not limited to, firmware, resident software, microcode, and the like.

Furthermore, the invention can take the form of a computer program product accessible from a computer-usable or computer-readable medium (for example, media 1318) providing program code for use by or in connection with a computer or any instruction execution system. For the purposes of this description, a computer usable or computer readable medium can be any apparatus for use by or in connection with the instruction execution system, apparatus, or device

The medium can be an electronic, magnetic, optical, electromagnetic, infrared, or semiconductor system (or apparatus or device) or a propagation medium. Examples of a computer-readable medium include a semiconductor or solid-state memory (for example memory 1304), magnetic tape, a removable computer diskette (for example media 1318), a random access memory (RAM), a read-only memory (ROM), a rigid magnetic disk and an optical disk. Current examples of optical disks include compact disk-read only memory (CD-ROM), compact disk-read/write (CD-R/W) and DVD

A data processing system suitable for storing and/or executing program code will include at least one processor 1302 coupled directly or indirectly to memory elements 1304 through a system bus 1310. The memory elements can include local memory employed during actual execution of the program code, bulk storage, and cache memories which provide temporary storage of at least some program code in older to reduce the number of times code must be retrieved from bulk storage during execution.

Input/output or I/O devices (including but not limited to keyboards 1308, displays 1306, pointing devices, and the like) can be coupled to the system either directly (such as via bus 1310) or through intervening I/O controllers (omitted for clarity).

Network adapters such as network interface 1314 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for analyzing test coverage of distributed processes, said method comprising the steps of
identifying at least one of said processes that is invoked by a test case;
mapping at least a portion of said test case to a plurality of specific test paths in said at least one of said processes; and
identifying given ones of said test paths as possibly relevant test paths in said at least one of said processes, if said given ones of said test paths are not infeasible.

2. The method of claim 1, further comprising facilitating provision of a report that describes test coverage

3. The method of claim 2, wherein said report describes said test coverage in a quantitative manner, by identifying a specific sub-set of said test paths that are covered by said test case.

4. The method of claim 2, wherein said report describes said test coverage in a qualitative manner, by identifying a percentage of said test paths covered by said test case.

5. The method of claim 1, wherein said step of identifying given ones of said test paths as possibly relevant test paths comprises identifying substantially all possibly relevant test paths.

6. The method of claim 1, wherein said test coverage comprises static test-case coverage and wherein said distributed processes choreograph distributed web-based software modules.

7. The method of claim 1, further comprising the additional step of repeating said steps of identifying said at least one of said processes, mapping, and identifying said given ones of said test paths for a plurality of additional test cases.

8. The method of claim 7, wherein at least some of said test cases are described in documents.

10. The method of claim 7, wherein at least some of said test cases are described in conceptual use cases.

11. The method of claim 7, wherein at least some of said test cases are described programmatically in an automated test tool

12. The method of claim 7, wherein said test cases comprise actionable test cases and form a portion of a test plan, said test plan further comprising a list of desirable outcomes for each of said test cases and a list of associated processes for verifying said desirable outcomes.

13. The method of claim 12, further comprising the additional step of facilitating documenting results of running said test cases.

14. The method of claim 7, wherein said distributed processes each comprise a construct describing choreography of at least one service to complete at least one task.

15. The method of claim 14, wherein at least some of said constructs are executable, and wherein said test cases define direct invocation of said executable constructs.

16. The method of claim 14, wherein at least some of said constructs are conceptual, and wherein said test cases define invocation of executable realizations of said conceptual constructs.

17. The method of claim 14, wherein said at least one service comprises a web service.

18. The method of claim 1, wherein at least some of said processes are defined in Business Process Execution Language.

19. The method of claim 1, wherein, in said step of identifying given ones of said test paths, said given ones of said test paths are limited to those that can be traced back to enterprise requirements.

20. The method of claim 1, wherein, in said step of identifying given ones of said test paths, said given ones of said test paths are identified to facilitate test coverage of every service of every service provider associated with said distributed processes.

21. The method of claim 1, wherein:
at least some of said processes are defined in Business Process Execution Language, comprising in turn at least decision points and branches; and
in said step of identifying given ones of said test paths, said given ones of said test paths are identified to facilitate test coverage of all feasible combinations of all said branches of all said decision points.

22. The method of claim 1, wherein, in said step of identifying given ones of said test paths, said given ones of said test paths are identified to facilitate derivation of multiple test cases for said given ones of said test paths.

23. A method for analyzing test coverage of distributed processes associated with a plurality of software modules of a customer; said software modules being from a plurality of software vendors, said method comprising the steps of:
identifying, by a service provider, at least one of said processes that is invoked by a test case;
mapping, by said service provider, at least a portion of said test case to a plurality of specific test paths in said at least one of said processes;
identifying, by said service provider; given ones of said test paths as possibly relevant test paths in said at least one of said processes, if said given ones of said test paths are not infeasible; and
facilitating provision of a report to said customer that describes test coverage;
wherein at least some of said software modules of said customer are not products of said service providers.

24. The method of claim 23, wherein, in said step of identifying given ones of said test paths, said given ones of said test paths are identified to facilitate test coverage associated with at least one of enterprise process, composite application, service, and higher level enterprise requirements of said customer.

25. A method for analyzing test coverage of distributed processes associated with a plurality of software modules of a customer, said method comprising the steps of:
identifying, by a service provider; at least one of said processes that is invoked by a test case;
mapping, by said service provider, at least a portion of said test case to a plurality of specific test paths in said at least one of said processes;
identifying, by said service provider; given ones of said test paths as possibly relevant test paths in said at least one of said processes, if said given ones of said test paths are not infeasible;
facilitating provision of a report to said customer that describes test coverage; and
responsive to said customer indicating that said test coverage requires enhancement, designing at least one new test case to enhance said test coverage.

26. A computer program product comprising a computer useable medium including computer usable program code for analyzing test coverage of distributed processes associated with a plurality of software modules of a customer, said software modules being from a plurality of software vendors, said computer program product including:
computer usable program code for identifying, by a service provider, at least one of said processes that is invoked by a test case;
computer usable program code for mapping, by said service provider, at least a portion of said test case to a plurality of specific test paths in said at least one of said processes;
computer usable program code for identifying, by said service provider, given ones of said test paths as possibly relevant test paths in said at least one of said processes, if said given ones of said test paths are not infeasible; and
computer usable program code for facilitating provision of a report to said customer that describes test coverage;
wherein at least some of said software modules of said customer are not products of said service provider.

27. The computer program product of claim 26, wherein, in said computer usable program code for identifying given ones of said test paths, said given ones of said test paths are identified to facilitate test coverage associated with at least one of enterprise process, composite application, service, and higher level enterprise requirements of said customer.

28. A computer program product comprising a computer useable medium including computer usable program code for analyzing test coverage of distributed processes, said computer program product including:
computer usable program code for identifying at least one of said processes that is invoked by a test case;
computer usable program code for mapping at least a portion of said test case to a plurality of specific test paths in said at least one of said processes; and
computer usable program code for identifying given ones of said test paths as possibly relevant test paths in said at least one of said processes, if said given ones of said test paths are not infeasible.

29. The computer program product of claim 28, further comprising computer usable program code for facilitating provision of a report that describes test coverage.

30. The computer program product of claim 29, wherein said report describes said test coverage in a quantitative manner, by identifying a specific sub-set of said test paths that are covered by said test case.

31. The computer program product of claim 29, wherein said report describes said test coverage in a qualitative manner, by identifying a percentage of said test paths covered by said test case.

32. The computer program product of claim 28, wherein said computer usable program code for identifying given ones of said test paths as possibly relevant test paths comprises computer usable program code for identifying substantially all possibly relevant test paths.

33. The computer program product of claim 28, wherein said test coverage comprises static test-case coverage and wherein said distributed processes choreograph distributed web-based software modules.

34. The computer program product of claim 28, further comprising computer usable program code for repeating said steps of identifying said at least one of said processes, mapping, and identifying said given ones of said test paths for a plurality of additional test cases.

35. The computer program product of claim 28, wherein at least some of said processes are defined in Business Process Execution Language.
